(19) United States
(12) Patent Application Publication
(10) Pub. No.: US 2024/0020439 A1
(43) Pub. Date: Jan. 18, 2024

(54) DEVICE AND METHOD FOR ANALYZING DURABILITY OF DRIVE LINE FOR VEHICLE

(71) Applicant: ANSYS, INC., Canonsburg, PA (US)

(72) Inventors: Hui Je CHO, Uiwang-si (KR); Chul Ho Lee, Yongin-si (KR); Heung Hyek Yim, Seongnam-si (KR); Min Uk Lee, Hanam-si (KR)

(21) Appl. No.: 18/373,924

(22) Filed: Sep. 27, 2023

Related U.S. Application Data
(63) Continuation of application No. PCT/KR2022/004287, filed on Mar. 28, 2022.

(30) Foreign Application Priority Data
Mar. 29, 2021 (KR) 10-2021-0040509

(51) Int. Cl. G06F 30/20; G06F 30/15

(52) U.S. Cl. CPC G06F 30/20; G06F 30/15; G06F 2119/02

(57) ABSTRACT

The present invention relates to an apparatus and a method of analyzing durability of a drive line for a vehicle, and more particularly, to a durability analysis automation technology which automates a durability analysis process performed for verifying durability performance in a stage of designing a drive line to easily and rapidly verify durability performance of the drive line.

### TECHNICAL FIELD

This application claims priority to and the benefit of Korean Patent Application No. 10-2021-0040509 filed in the Korean Intellectual Property Office on Mar. 29, 2021, the entire contents of which are incorporated herein by reference.

The present invention relates to an apparatus and a method of analyzing durability of a drive line for a vehicle, and more particularly, to a durability analysis automation technology which automates a durability analysis process performed for verifying durability performance in a stage of designing a drive line to easily and rapidly verify durability performance of the drive line.

### BACKGROUND ART

A drive line in a vehicle may refer to a part designed to operate the wheel by transmitting an output generated in an engine or a motor in a drive system of the vehicle and transmitted to a shaft through a transmission, and may include constituent elements, such as a shaft, a gear, a bearing, and a housing.

In the meantime, in order to develop the drive line, it is necessary to verify durability performance, and accordingly, a durability analysis process including fatigue analysis and the like through a simulation is performed when the drive line is designed.

In this case, a method of analyzing durability of a drive line in the related art is performed by manually receiving data of constituent elements of the drive line required in each progress operation, and has a problem in that the design time is very long, and in a structure analysis method for each constituent element applied to the durability analysis method in the related art, depending on the type of set boundary condition or finite element modelling method, there is a large deviation in the derived analysis result, so that there is a hassle of having to investigate the mesh and boundary condition types for each constituent element in advance.

### DISCLOSURE

### Technical Problem

The present invention is conceived to solve the foregoing problems, and is to provide an apparatus and a method of analyzing durability of a drive line for a vehicle, which are capable of automatically acquiring data for each constituent element of a drive line that has to be transmitted manually in the related art, and automatically generating a durability analysis model for analyzing durability of the drive line to significantly decreasing the time required for durability analysis and calculate stress of the durability analysis model without an investigation of a boundary condition.

### Technical Solution

An exemplary embodiment of the present invention provides a method of analyzing durability of a drive line for a vehicle, the method including: generating a three-dimensional (3D) model for each constituent element included in a drive line; preparing a definition of a durability analysis model for each constituent element based on data of the generated 3D model; defining a driving condition for each system related to the drive line; defining a durability analysis model for each constituent element and performing a dynamics analysis; and performing a fatigue analysis for the durability analysis model by reflecting a result of the dynamics analysis.

In the exemplary embodiment, the generating of the 3D model for each constituent element may include allocating an appointed identifier for each type of the generated 3D model.

In the exemplary embodiment, the preparing of the definition of the durability analysis model may include: detecting an identifier allocated to each 3D model; and acquiring design data for a 3D model identified through the detected identifier.

In the exemplary embodiment, the preparing of the definition of the durability analysis model may include investigating the identified 3D model based on the acquired design data, and preparing the definition of the durability analysis model so that the durability analysis model reflecting the result of the investigation is automatically defined.

In the exemplary embodiment, the defining of the driving condition for each system may include: defining a driving condition related to a power transmission path; defining a driving condition related to an engine or a motor; defining a driving condition related to a transmission or a decelerator; defining a driving condition related to specifications, braking, and load of a vehicle; and defining a driving condition related to an Accelerator Pedal Sensor (APS), a Brake Pedal Sensor (BPS), and regenerative braking.

In the exemplary embodiment, the defining of the driving condition for each system may include analyzing Revolutions Per Minute (RPM) of an input shaft and a torque of an output shaft of the transmission based on a driving condition defined for each system related to the drive line, and extracting the driving condition of the drive line based on a result of the analysis of the RPM of the input shaft and the torque of the output shaft of the transmission.

In the exemplary embodiment, the performing of the dynamics analysis may include: defining a durability analysis model for a shaft; defining a durability analysis model for a gear; defining a durability analysis model for a bearing; defining a durability analysis model for a housing; and defining a durability analysis model for a connection structure between the detailed constituent elements.

In the exemplary embodiment, the performing of the dynamics analysis may include calculating a load condition for the durability analysis model defined for each constituent element by performing the dynamics analysis to which the extracted driving condition is applied.

In the exemplary embodiment, the performing of the fatigue analysis may include: selecting a durability analysis model to perform the fatigue analysis among the defined durability analysis models; and defining a fatigue property for the selected durability analysis model.

In the exemplary embodiment, the performing of the fatigue analysis may include: performing a static analysis for calculating stress by applying the calculated load condition to the selected durability analysis model; and performing a fatigue analysis for calculating durability life for the selected durability analysis model.

Another exemplary embodiment of the present invention provides an apparatus for analyzing durability of a drive line for a vehicle, the apparatus including: a 3D model loading unit configured to load a 3D model implementing each constituent element included in a drive line; a model data investigating unit configured to prepare a definition of a durability analysis model for each constituent element based on data of the loaded 3D model; a driving condition defining unit configured to define a driving condition for each system related to the drive line; a dynamics analysis performing unit configured to define the durability analysis model for each constituent element and perform a dynamics analysis; and a fatigue analysis performing unit configured to perform a fatigue analysis for the durability analysis model by reflecting a result of the dynamics analysis.

### Advantageous Effects

The apparatus and the method of analyzing durability of a drive line for a vehicle according to the exemplary embodiments of the present invention automatically acquire and investigate the constituent element of the drive line, so that there is an effect in that the time consumed for generating the durability analysis model is greatly decreased.

The apparatus and the method of analyzing durability of a drive line for a vehicle according to the exemplary embodiments of the present invention calculate stress by using a load of a boundary portion calculated through the dynamics analysis without using a structure analysis method for each constituent element, so that there is an advantage in that it is not necessary to investigate and designate a boundary condition for each constituent element.

### DESCRIPTION OF DRAWINGS

FIG. 1 is a reference diagram for describing a system for analyzing durability of a drive line for a vehicle according to the present invention.

FIG. 2 is a block diagram illustrating a configuration of an apparatus for analyzing durability of a drive line for a vehicle according to the present invention.

FIG. 3 is a reference diagram illustrating a durability analysis model defined according to an exemplary embodiment of the present invention.

FIG. 4 is a reference diagram illustrating a static analysis process for the durability analysis model defined according to the exemplary embodiment of the present invention.

FIG. 5 is a reference diagram illustrating a fatigue analysis result of a constituent element of the drive line for a vehicle according to the exemplary embodiment of the present invention.

FIG. 6 is a flow chart illustrating a method of analyzing durability of a drive line for a vehicle according to the present invention.

### MODE FOR CARRYING OUT THE INVENTION

The present invention may have various modifications and exemplary embodiments and thus specific exemplary embodiments will be illustrated in the drawings and described. However, it is not intended to limit the present invention to the specific exemplary embodiments, and it will be appreciated that the present invention includes all modifications, equivalences, or substitutions included in the spirit and the technical scope of the present invention. However, in the description of the present invention, when a detailed description of a related publicly known function or constituent element is determined to unnecessarily make the subject matter of the present invention unclear, the detailed description thereof will be omitted.

Terms, such as first and second, may be used for describing various constituent elements, but the constituent elements are not limited by the terms. The terms are used only to discriminate one constituent element from another constituent element.

Terms used in the present application are used only to describe specific exemplary embodiments, and are not intended to limit the present invention. Singular expressions used herein include plurals expressions unless they have definitely opposite meanings in the context. In the present specification, it should be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Hereinafter, an exemplary embodiment of the present invention will be described in detail with reference to the accompanying drawings.

In addition, the term “- unit” described in the specification means a unit for processing at least one function and operation and can be implemented by hardware components or software components and combinations thereof.

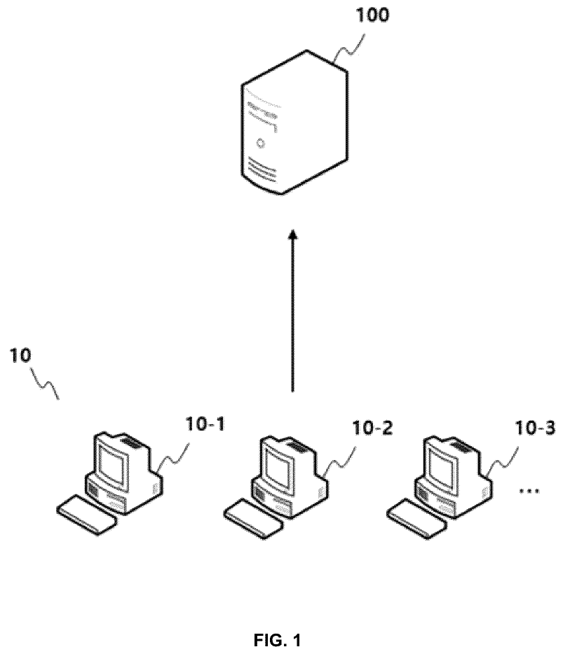

FIG. 1 is a reference diagram for describing a system for analyzing durability of a drive line for a vehicle (hereinafter, a durability analysis system) according to the present invention.

Referring to FIG. 1, the durability analysis system may include a 3D model generating device 10 and an apparatus 100 for analyzing durability of a drive line (hereinafter, the durability analysis apparatus), and the durability analysis apparatus 100 may receive data for a 3D model generated from the 3D model generating device 10 and use the received data for performing the durability analysis of the drive line according to the present invention. Herein, the data for the 3D model may include data in which each constituent element of the drive line is modeled, that is, model data in which each constituent element is three-dimensionally implemented, and may include, for example, CAD model data in which each constituent element is three-dimensionally modeled by using a CAD.

Further, FIG. 1 is for describing the feature that the durability analysis apparatus 100 is capable of receiving the data for the 3D model generated from the 3D model generating device 10, and it is not intended to limit that the durability analysis apparatus 100 receives the 3D model data through the 3D model generating device 10. For example, the durability analysis apparatus 100 may perform the durability analysis by downloading the 3D model data from the cloud to which the data of the 3D model generated in a plurality of 3D model generating devices 10-1, 10-2, 10-3, and . . . is uploaded. Further, in another exemplary embodiment of the present invention, the durability analysis apparatus 100 is configured to include the 3D model generating device 10 or a 3D model generating function, so that the durability analysis apparatus 100 may perform the durability analysis by receiving the data of the 3D model without the need to transmit data between the devices.

Further, the 3D model generating device 10 according to the present invention means an electronic device capable of generating the 3D model, and may include, for example, a desk top PC, a tablet PC, and a notebook computer, but the 3D model generating device 10 is not limited thereto, and any electronic device capable of generating the 3D model according to the present invention may be interpreted as the 3D model generating device 10.

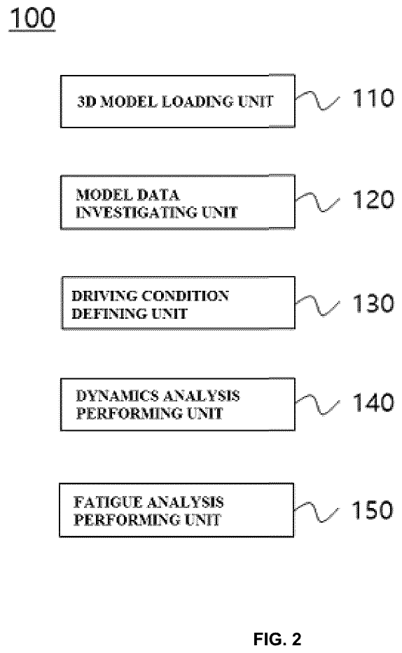

FIG. 2 is a block diagram illustrating a configuration of the durability analysis apparatus 100 according to the present invention.

Referring to FIG. 2, the durability analysis apparatus 100 according to the present invention may include a 3D model loading unit 110, a model data investigating unit 120, a driving condition defining unit 130, a dynamics analysis performing unit 140, and a fatigue analysis performing unit 150. Hereinafter, the constituent elements of the durability analysis apparatus 100 are not limited thereto, and further include, for example, a 3D model generating unit performing a function of generating the 3D model data.

The 3D model generating unit may generate a 3D model implementing each constituent element included in the drive line.

In the exemplary embodiment, the 3D model generating unit may allocate an appointed identifier for each type of the generated 3D model. Herein, the appointed identifier may be allocated for the purpose of identifying which of the constituent elements constituting the drive line corresponds to the generated 3D model corresponds to the durability analysis apparatus 100 according to the present invention, and the identifier may include a code or a model name that is allocated differently for each type of the generated 3D model.

The 3D model loading unit 110 may load the 3D model implementing each constituent element included in the drive line.

In the exemplary embodiment, the 3D model loading unit 110 may load the 3D model generated in the 3D model generating unit or the 3D model generating device 10. Herein, data for the loaded 3D model may be loaded together, and the data for the 3D model may be used for defining the durability analysis model later.

The model data investigating unit 120 may prepare the definition of the durability analysis model for each constituent element based on the data of the loaded 3D model.

In the exemplary embodiment, the model data investigating unit 120 may detect the identifier allocated to each 3D model, and acquire design data for the 3D model identified through the detected identifier. Herein, the design data may include specifications including positions, masses, and materials for the constituent element of the drive line corresponding to the identified 3D model.

In the exemplary embodiment, the model data investigating unit 120 may investigate the identified 3D model based on the acquired design data, and prepare the durability analysis model to which a result of the investigation is reflected to be automatically defined. Herein, the model data investigating unit 120 may extract information to be input for defining the durability analysis model later from the acquired design data in advance. Further, the model data investigating unit 120 may provide a user with a result of investigating whether information about the constituent element corresponding to the identified 3D model is omitted and information about the constituent element corresponding to the identified 3D model has an error. For example, when the omission or the error of the information about the corresponding constituent element is found, the model data investigating unit 120 corrects a corresponding problem based on a user input applied to the durability analysis apparatus 100 from the user, to prepare the durability analysis model for the constituent element of the drive line corresponding to the identified 3D model to be automatically defined.

The driving condition defining unit 130 may define a driving condition for each system related to the drive line.

In the exemplary embodiment, the driving condition defining unit 130 may define a driving condition related to a power transmission path. Herein, as the power transmission path, for example, a power transmission path connected from an engine of the vehicle, to a first shaft, a gear pair, a second shaft, and the wheel may be set.

In the exemplary embodiment, the driving condition defining unit 130 may define a driving condition related to an engine or a motor. Herein, the driving condition related to the engine or the motor may include specifications of the engine or the motor.

In the exemplary embodiment, the driving condition defining unit 130 may define a driving condition related to a transmission or a decelerator. Herein, the driving condition related to the transmission or the decelerator may include specifications of the transmission or the decelerator.

In the exemplary embodiment, the driving condition defining unit 130 may define driving conditions related to specifications, braking, and load of the vehicle.

In the exemplary embodiment, the driving condition defining unit 130 may define a driving condition related to an Accelerator Pedal Sensor (APS), a Brake Pedal Sensor (BPS), and regenerative braking.

In the exemplary embodiment, the driving condition defining unit 130 may analyze Revolutions Per Minute (RPM) of an input shaft and a torque of an output shaft of the transmission based on the driving condition defined to each system related to the drive line, and extract the driving condition of the drive line based on an analysis result for the RPM of the input shaft and the torque of the output shaft of the transmission.

In the exemplary embodiment, the driving condition of the drive line may include a load applied to the drive line according to a vehicle travelling scenario. Herein, the vehicle travelling scenario is assumed according to different vehicle travelling characteristics, and may include a plurality of vehicle travelling scenarios.

The dynamics analysis performing unit 140 may define a durability analysis model for each constituent element and perform a dynamics analysis.

In the exemplary embodiment, the dynamics analysis performing unit 140 may define a durability analysis model for the shaft.

In the exemplary embodiment, the dynamics analysis performing unit 140 may define a durability analysis model for a gear.

In the exemplary embodiment, the dynamics analysis performing unit 140 may define a durability analysis model for a bearing.

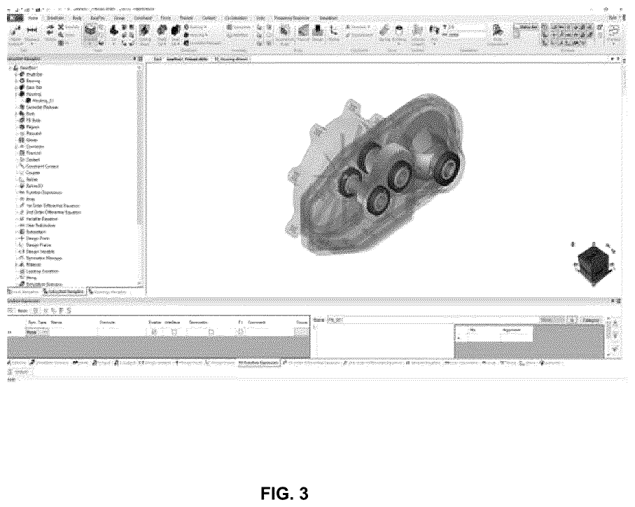

In the exemplary embodiment, the dynamics analysis performing unit 140 may define a durability analysis model for a housing. Herein, FIG. 3 is a reference diagram illustrating the durability analysis model defined according to the exemplary embodiment of the present invention. Referring to FIG. 3, the durability analysis models of the shaft, the gear, the bearing, the housing, and the like defined by the dynamics analysis performing unit 140 according to the exemplary embodiment of the present invention may be checked.

In the exemplary embodiment, the dynamics analysis performing unit 140 may define the durability analysis model for the connection structure between the detailed constituent elements.

In the exemplary embodiment, the dynamics analysis performing unit 140 may calculate a load condition for the durability analysis model defined for each constituent element by performing the dynamics analysis to which the driving condition extracted by the driving condition defining unit 130 is applied.

The fatigue analysis performing unit 150 may performing a fatigue analysis for the durability analysis model by reflecting the result of the dynamics analysis.

In the exemplary embodiment, the fatigue analysis performing unit 150 may select a durability analysis model which is to perform the fatigue analysis among the defined durability analysis models.

In the exemplary embodiment, the fatigue analysis performing unit 150 may define a fatigue property for the selected durability analysis model.

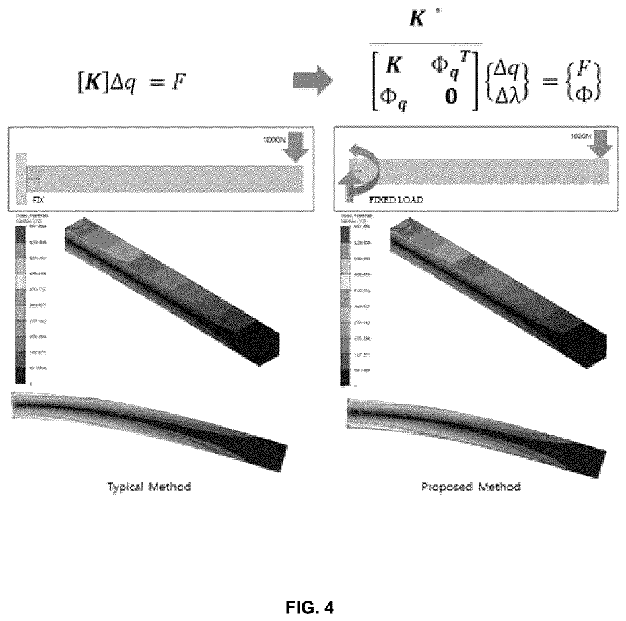

In the exemplary embodiment, the fatigue analysis performing unit 150 may perform a static analysis for calculating stress by applying the calculate load condition to the selected durability analysis model. Herein, the calculated load condition may include the load calculated to a boundary portion of the defined durability analysis model, and when the load calculated for the boundary portion is used, there is no need to separately designate and investigate a boundary condition for the model to be analyzed. In relation to this, FIG. 4 is a reference diagram illustrating a static analysis process for the durability analysis model defined according to the exemplary embodiment of the present invention. FIG. 4 illustrates the visualization of the result of the calculation of the load applied to the boundary portion of the durability analysis model.

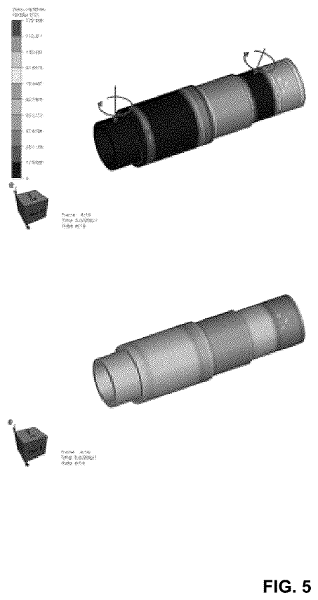

In the exemplary embodiment, the fatigue analysis performing unit 150 may perform the fatigue analysis of calculating durability life of the selected durability analysis model. Herein, FIG. 5 is a reference diagram illustrating a fatigue analysis result of a constituent element of the drive line for the vehicle according to the exemplary embodiment of the present invention. Referring to FIG. 5, the fatigue analysis performing unit 150 may calculate durability life for the durability analysis model, and visualize a result of the calculation of the durability life and provide a result of the visualization through the user terminal. The visualized result of the calculation of the durability life enables the user to intuitively check a fatigue application state including the durability life for the durability analysis model.

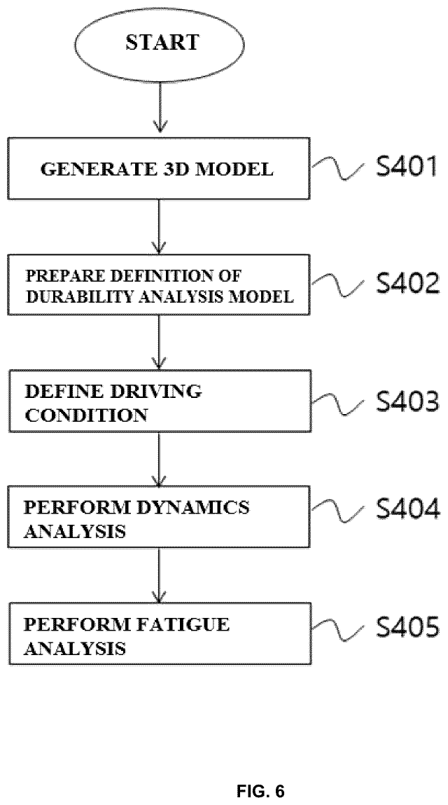

FIG. 6 is a flow chart illustrating a method of analyzing durability of a drive line for a vehicle according to the present invention.

Referring to FIG. 6, first, a 3D model for each constituent element included in a drive line for a vehicle is generated (S401). Herein, an identifier that makes it possible to identify each constituent element is allocated to the generated 3D model, and the identifier may automatically generate the durability analysis model for the generated 3D model of the present invention.

Next, a definition of the durability analysis model for each constituent element is prepared based on data of the generated 3D model (S402). Here, the data of the 3D model may include design data, and the like of the constituent element of the drive line, and as a previous operation of the definition of the durability analysis model, an investigation of the 3D model may be performed based on the data.

Next, a driving condition for each system related to the drive line is defined (S403). Herein, each system related to the drive line may include a power transmission path, an engine (motor), a transmission (decelerator), vehicle specifications, and a braking system, and a scenario for each travelling characteristic of the vehicle may also be included in the driving condition to define the driving condition.

Next, a durability analysis model for each constituent element is defined, and a dynamics analysis is performed (S404). Herein, the durability analysis model for each constituent element may be defined by applying the defined driving condition, and a load condition for the defined durability analysis model may be calculated and used in the fatigue analysis operation.

Next, the fatigue analysis for the durability analysis model is performed by reflecting the result of the dynamics analysis (S405). Herein, the fatigue analysis may be performed on a durability analysis model selected by a user's input, and may include fatigue property definition, stress calculation, and durability life calculation processes for the durability analysis model.

The foregoing durability analysis method of the drive line has been described with reference to the flow chart presented in the drawing. For the simple description, the method is illustrated and described with the series of blocks, but the present invention is not limited to the order of the blocks, and some blocks may be occurred in the different order from the order illustrated and described in the present specification or may be occurred with other blocks at the same time, and various other branches, a flow path, and orders of the blocks achieving the same or similar result may be implemented. Further, not all illustrated blocks may be required for implementation of the method described in the present specification.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A method of analyzing durability of a drive line for a vehicle, the method comprising:
generating a three-dimensional (3D) model for each constituent element included in a drive line;
defining a durability analysis model for each constituent element based on data of the generated 3D model, a driving condition for each system related to the drive line, and a durability analysis model for each constituent element;
performing a dynamics analysis; and
performing a fatigue analysis for the durability analysis model by reflecting a result of the dynamics analysis.

2. The method of claim 1, wherein the generating of the 3D model for each constituent element includes allocating an appointed identifier for each type of the generated 3D model.

3. The method of claim 2, wherein defining the durability analysis model includes:
detecting an identifier allocated to each 3D model; and
acquiring design data for a 3D model identified through the detected identifier.

4. The method of claim 3, wherein defining the durability analysis model includes investigating the identified 3D model based on the acquired design data, and wherein the durability analysis model reflecting the result of the investigation is automatically defined.

5. The method of claim 1, wherein the defining of the driving condition for each system includes:
defining a driving condition related to a power transmission path;
defining a driving condition related to an engine or a motor;
defining a driving condition related to a transmission or a decelerator;
defining a driving condition related to specifications, braking, and load of a vehicle; and
defining a driving condition related to an Accelerator Pedal Sensor (APS), a Brake Pedal Sensor (BPS), and regenerative braking.

6. The method of claim 5, wherein the defining of the driving condition for each system includes analyzing Revolutions Per Minute (RPM) of an input shaft and a torque of an output shaft of the transmission based on a driving condition defined for each system related to the drive line, and extracting the driving condition of the drive line based on a result of the analysis of the RPM of the input shaft and the torque of the output shaft of the transmission.

7. The method of claim 6, wherein the performing of the dynamics analysis includes:
defining a durability analysis model for a shaft;
defining a durability analysis model for a gear;
defining a durability analysis model for a bearing;
defining a durability analysis model for a housing; and
defining a durability analysis model for a connection structure between the detailed constituent elements.

8. The method of claim 7, wherein the performing of the dynamics analysis includes calculating a load condition for the durability analysis model defined for each constituent element by performing the dynamics analysis to which the extracted driving condition is applied.

9. The method of claim 8, wherein the performing of the fatigue analysis includes:
selecting a durability analysis model to perform the fatigue analysis among the defined durability analysis models; and
defining a fatigue property for the selected durability analysis model.

10. The method of claim 9, wherein the performing of the fatigue analysis includes:
performing a static analysis for calculating stress by applying the calculated load condition to the selected durability analysis model; and
performing a fatigue analysis for calculating durability life for the selected durability analysis model.

11. An apparatus for analyzing durability of a drive line for a vehicle, the apparatus comprising:
a 3D model loading unit configured to load a 3D model implementing each constituent element included in a drive line;
a model data investigating unit configured to prepare a definition of a durability analysis model for each constituent element based on data of the loaded 3D model;
a driving condition defining unit configured to define a driving condition for each system related to the drive line;
a dynamics analysis performing unit configured to define the durability analysis model for each constituent element and perform a dynamics analysis; and
a fatigue analysis performing unit configured to perform a fatigue analysis for the durability analysis model by reflecting a result of the dynamics analysis.
